(19) United States
(12) Patent Application Publication
(10) Pub. No.: US 2009/0208311 A1
(43) Pub. Date: Aug. 20, 2009

(54) One part receptable for a fastener

(76) Inventor: Christopher Churchill, Surrey (GB)

Correspondence Address: PAUL AND PAUL, 2000 MARKET STREET, SUITE 2900, PHILADELPHIA, PA, 19103, US

(21) Appl. No.: 10/583,394

(22) PCT Filed: Dec. 20, 2004
(86) PCT No.: PCT/US04/42807

§ 371 Date: Nov. 10, 2008

(30) Foreign Application Priority Data
Dec. 19, 2003 (EP) 03258061

(51) Int. Cl. F16B 21/00

(52) U.S. Cl. 411/516

(57) ABSTRACT

A one part receptacle for a fastener for insertion, in use, into a hole in a receiving component. The receptacle comprises a base with legs, at least one of the legs retaining the receptacle on a component in use. The base includes a hole for engaging, in use, with the fastener, and at least one leg is shaped to form a compliant mechanism which provides a compliant retaining force in the direction of insertion of the fastener. In use, the receptacle is inserted into the hole and retained thereon and provides compliance between the component on which it is retained and a second component attached thereto via the receptacle and fastener.

The present invention provides a one part receptacle for a fastener. The receptacle of the present invention provides a means by which a panel, such as a car noise shield or engine cover can be mounted onto a support by use of a fastener.

Receptacles for fasteners are well known in many fields, particularly in the automotive industry for use in mounting panels onto support materials.

An important factor which needs to be considered when designing a receptacle for a fastener is that during the use of the end product while the fastening needs to be secure, it also needs to include a degree of flexibility. When in use, an automobile is a high vibration environment and hence there is a need for a fastening which can tolerate such vibrations without causing any damage to the parts to which it is secured. It is clear that there is a need for a receptacle for a fastener specifically designed with such a high vibration environment in mind.

Many prior art receptacles are comprised of at least two components. This is because, when using such receptacles for fasteners of the prior art, in order to provide the necessary flexibility, an additional component such as a spring washer or grommet must be included. The reasoning behind the use of a separate receptacle for receiving a fastener is to increase the efficiency of the manufacturing process and reduce the number of time consuming operations which must be carried out manually on the production line. Inclusion of an additional component as is necessary in the prior art makes the manufacturing process both more complicated and more expensive. It would therefore be advantageous to provide a receptacle for a fastener which has an integrated spring mechanism such that no further components are required and the manufacturing process is both simpler and cheaper.

A further problem encountered in the prior art results when the component to which the receptacle for the fastener is attached and/or the component to be attached is not of uniform thickness. This can lead to a poor fit which not only results in a rattling noise during use but the fastening is not as secure and there is an increased likelihood that the fastening will work loose during use.

A variable thickness of the component or components can lead to a further problem. When using the receptacles for fasteners of the prior art, where one or both components are of a variable thickness, it is necessary to adjust the length of the fastener used to compensate for this variability and ensure that a secure fastening is achieved. This complicates the manufacturing process by causing both handling and stockholding problems. There is clearly a need for a receptacle for a fastener where a fastener of the same length can be used irrespective of the variable thickness of the component into which the receptacle is inserted and of the component to be attached.

In summary, it is therefore clear that there is a need for a single component receptacle for a fastener that can be securely fixed even where the components being attached to one another are of a non-uniform thickness and is sufficiently flexible that damage and rattling during use are avoided.

The present invention provides a one part receptacle for a fastener for insertion, in use, into a hole in a receiving component, the receptacle comprising a base with legs, at least one of the legs retaining the receptacle on a component in use, wherein the base includes a hole for engaging, in use, with the fastener and at least one of the legs is shaped to form a compliant mechanism which provides compliance in the direction of insertion of the fastener whereby, in use, the receptacle is inserted into the hole and retained thereon and provides compliance between the component on which it is retained and a second component attached thereto via the receptacle and fastener.

The purpose of the retaining leg is to ensure that the receptacle is locked firmly in position after it has been installed into the component. Preferably such a locking mechanism is provided by legs which expand behind the component after installation.

In addition, the inclusion of at least one leg shaped to form a compliant mechanism ensures that the receptacle of the present invention has sufficient flexibility to be appropriate for use in a high vibration environment such as in an automobile. Also, the receptacle of the invention is arranged such that it can operate over a considerable range of component thickness and provide an over-centre retaining force for the fastener in use.

The fact that the compliant mechanism is included as an integral part of the one part receptacle means that there is no need to include additional components such as washers and grommets. Consequently the manufacturing process is simplified and costs are reduced. This is exemplified by the fact that the receptacle of the present invention can be easily fixed manually into a hole in a component by use of a hand tool.

The at least one leg shaped to form a compliant mechanism is designed such that, even in the situation where the component into which it is inserted or to which it is attached, is of variable thickness, a good fit will still be achieved. The Inclusion of this compliant mechanism also means that it is not necessary to change the length of the fastener used to compensate for some variations in thickness. Hence the present invention overcomes the problems associated with the prior art in that a receptacle is provided that is a single component, is suitable for use in a high vibration environment and self adjusts to allow for a variation in the thickness of the components with which it is used.

At least one leg of the receptacle shaped to form a compliant mechanism is preferably comprised of at least one outer spring leg and an inner spring leg. It may be the inner spring leg which adjusts position to allow for a varying thickness of the component into which it is inserted and provides a retaining force thereon.

In a preferred example of the present invention, two of the legs, positioned on opposite sides of the base of the receptacle, are shaped to form a compliant mechanism to provide a compliant force in the direction of insertion of the fastener. A symmetrical arrangement is desirable as the resulting fastening is more secure.

In a further example the compliant mechanism comprises two outer legs and an inner spring leg. Preferably the end portion of the at least one outer spring leg is bent to form a wing extending laterally from the base such that, in use, the wing is positioned at an acute angle to the upper surface of the component into which it is inserted. More preferably the wing is positioned, in use, at an angle of about 30° to the upper surface of the component. Such positioning ensures that the required compliance is achieved. In such an example it is preferable that the lower portion of the outer spring leg extends in a direction substantially perpendicular to the base of the receptacle.

Where the at least one leg shaped to be a compliant mechanism comprises two outer legs and an inner leg, the outer legs may be separate or the end portions of the outer legs may be joined.

Where the at least one leg shaped to be a compliant mechanism comprises an inner compliant leg, this inner leg may be positioned at any point along the side of the base. In the example where the compliant mechanism comprises two outer legs, it is preferable that the inner leg is located centrally between the two outer legs.

Preferably the inner leg is positioned at an acute angle to the at least one outer leg. More preferably, the inner leg is positioned at an angle in the range 12-15° to the at least one outer leg. This ensures good retention on the component whilst providing good thickness tolerance.

Alternatively, in a example where the end portion of the outer leg is bent to form a wing extending laterally from the base, the end portion of the inner leg may also be bent back an itself to form a wing extending from the base at an acute angle to the vertical portion of the outer leg which extends in a direction substantially parallel to the direction of the direction of insertion of the fastener, such that, in use, the end portion of the inner leg is positioned at an acute angle to the end portion of the outer leg. In this example, in use, the end portions of the legs bias the receptacle against the Underside of the material to be attached to the component into which the receptacle is inserted. In such an example it is preferable that the lower portion of the inner leg extends in a direction substantially perpendicular to the base of the receptacle.

The one part receptacle for a fastener of the present invention is preferably formed from metal. More preferably, however, the receptacle is formed from carbon steel.

The receptacle of the present invention may be used with any fastener. The hole in the base is altered depending on the nature of the fastener to be engaged in use. Preferably the fastener is a quarter turn fastener.

The present invention also provides a fastener and receptacle combination comprising the receptacle as described previously which is installed into a hole in a component and a fastener which is engaged with the hole in the base of the receptacle.

The present invention provides a means by which a panel can be mounted onto a support material. In one example of the present invention, a panel may be pro-mounted on to the receptacle prior to installation into the component to further improve the manufacturing process. Preferably the panel is a car noise shield or engine cover. The panel is preferably made of plastic with a thickness in the range of 2-3 mm.

Two examples of the present invention are now described with reference to the following figures, in which:

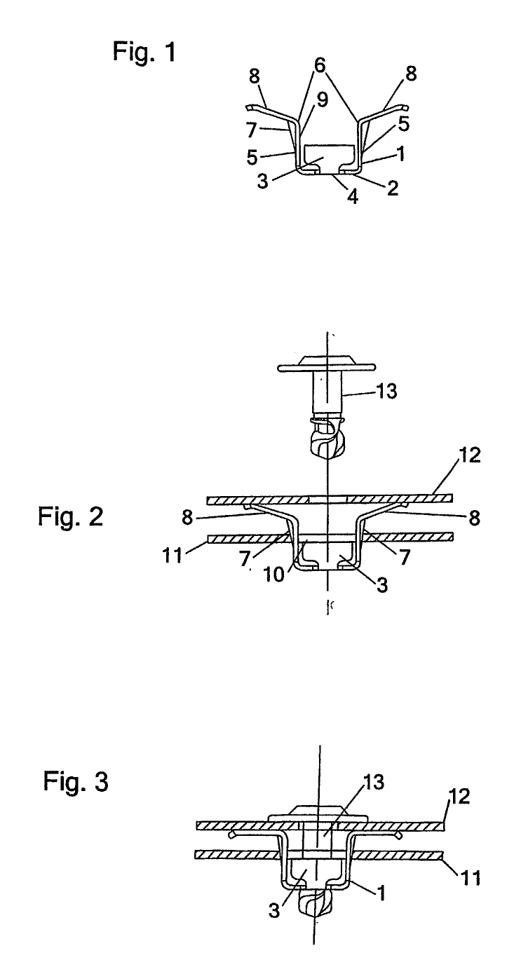

FIG. 1 is a side view of a first example of the one part receptacle for a fastener of the present invention;

FIG. 2 is a side view of a first example of the receptacle installed into a component;

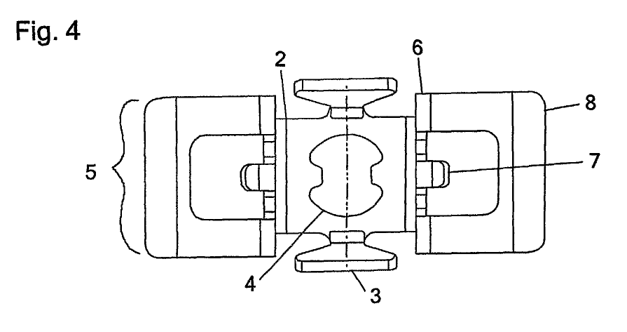

FIG. 3 is a side view of a first example in which a panel has been attached to a component by engaging a fastener with the receptacle installed in the component;

FIG. 4 is a plan view of a first example of the one part receptacle for a fastener of the present invention;

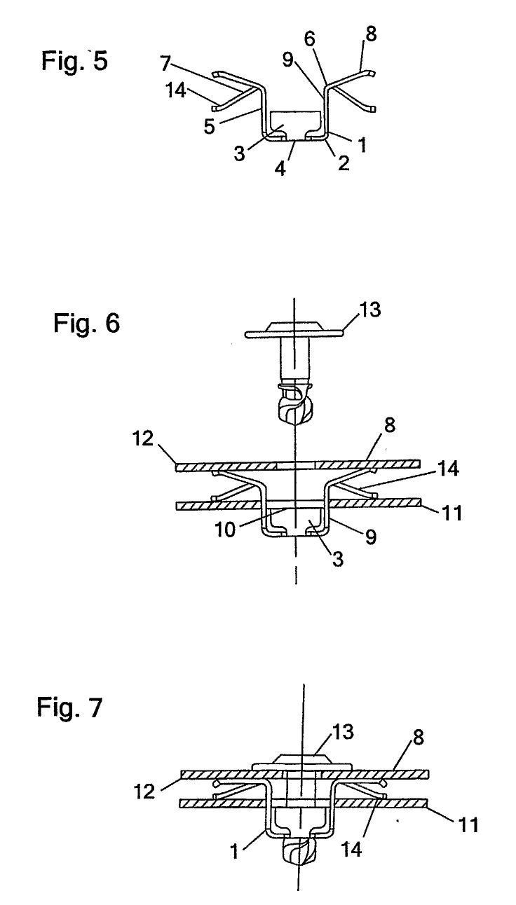

FIG. 5 is a side view of a second example of the one part receptacle for a fastener of the present invention;

FIG. 6 is a side view of a second example of the receptacle installed into a component;

FIG. 7 is a side view of a second example in which a panel has been attached to a component by engaging a fastener with the receptacle installed in the component; and

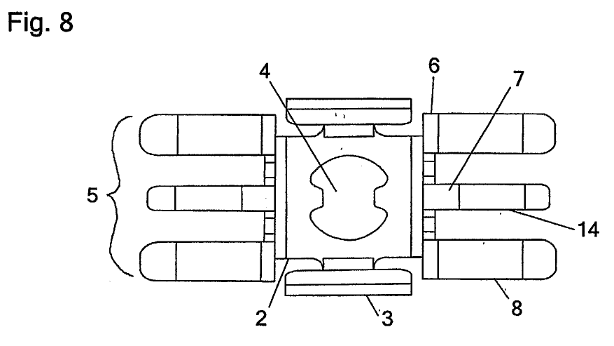

FIG. 8 is a plan view of a second example of the one part receptacle for a fastener of the present invention.

A first example of the one part receptacle of the present invention is illustrated by FIGS. 1-4. A square base 2 and two retaining legs 3 are provided on opposite sides of the base 2 and are paddle shaped and extend in a direction opposite to the direction of insertion of the fastener from the base 2 of the receptacle 1. The base 2 contains a hole 4 suitable for engaging, in use, with a quarter turn fastener (13—FIG. 2). Two further legs 5, opposite one another on the remaining sides of the base 2 are each shaped to form a compliant mechanism which provides a compliant retaining force in the direction of insertion of the fastener. Each spring mechanism is, in this example, the same and comprises two outer legs 6 and an inner central spring leg 7. The end portions 8 of the outer legs 6 which extend laterally outwards from the base 2 are joined to form a “C shaped” wing section as shown in FIG. 4. The inner spring leg 7 extends in a direction opposite to the direction of insertion of the fastener from the base 2 and is positioned, in this example, at an angle in the range 12-15° to the vertical sections 9 of the outer legs 6 which extend in a direction substantially parallel to the direction of insertion. This provides a secure retention on component 11, which resists forces applied to end portions 8, and which is tolerant of changes in the thickness of component 11 as well as providing vibration resistance.

In use, upon inserting the receptacle 1 into a substantially square hole 10 in a component 11, the retaining legs 3 extend outwards to lock the receptacle 1 in place. After insertion, the position of the central spring leg 7 adjusts to allow for any variation in the thickness of the component 11 and the wing portions 8 of the outer legs 6 are positioned at an angle of approximately 30° to the upper surface of the component 11. In this position the outer legs 6 act as a compliant element in the direction of insertion of the fastener and hence ensure that the fastening has the desired flexibility.

As illustrated in FIG. 3, in use, a panel 12 is attached to the component 11 by engaging a quarter turn fastener 13 with the hole 4 in the base 2 of the receptacle 1 installed into the component 11. The compliant end portions 8 of outer legs 6 adjust so as to allow a secure fastening which still has sufficient flexibility to tolerate a high vibration environment. The compliant force generated by this also provides the fastener 13 with the necessary overcentering to retain it in place and allow for the arrangement to work on a wide range of panel thickness.

A second example of the present invention is illustrated in FIGS. 5-8. As in the first example, the receptacle 1 comprises a square base 2 and two retaining legs 3 are provided on opposite sides of the base 2 and are paddle shaped and extend in a direction opposite to the direction of insertion of the fastener from the base 2 of the receptacle 1. The base 2 again contains a hole 4 suitable for engaging, in use, with a quarter turn fastener (13—FIG. 6). Two further legs 5, opposite one another on the remaining sides of the base, are each shaped to form a compliant mechanism which provides a compliant retaining force during insertion of the fastener. In this example, each mechanism is the same and comprises two outer legs 6 and an inner central leg 7. The end portions 8 of the outer legs 6 extend laterally from the base as shown in FIG. 8. The end portion 14 of the inner spring leg 7 is bent back on itself to form a wing extending from the base at an acute angle to the vertical portions 9 of the outer spring legs 6 which extend in a direction substantially parallel to the direction of insertion. This again ensures a secure retaining force on component 11 which is resistant to forces applied to end portions 8 and tolerant to variations in thickness of component 11.

In use, upon inserting the receptacle 1 into a substantially square hole 10 in the component 11, the retaining legs 3 extend outwards to lock the receptacle 1 in position. After insertion, in this example, the end portion 14 of the inner leg is positioned at an acute angle to the portion 9 of the outer legs.

As in the first example, in use, a panel 12 is attached to the component 11 by engaging a quarter turn fastener 13 with the hole 4 in the receptacle 1 installed in the component 11 as can be seen in FIG. 7. In this example the relative positioning of the end portion 14 of the inner leg and the end portion 8 of the outer leg adjusts such that the acute angle between them is decreased, providing compliance to compensate for panel 12 and component 11 thickness variations and a force which absorbs vibration forces. Again this force also retains the fastener in its engaged position. Because this example engages on the surface of both component 11 and panel 12 improved vibration resistance is achieved, and a secure fastening results which still has sufficient flexibility to tolerate a high vibration environment.

1. A one part receptacle for a fastener for insertion, in use, into a hole in a receiving component, the receptacle comprising a base with legs, at least one of the legs retaining the receptacle on a component in use, wherein the base includes a hole for engaging, in use, with the fastener, and at least one leg is shaped to form a compliant mechanism which provides a compliant retaining force in the direction of insertion of the fastener, whereby, in use, the receptacle is inserted into the hole and retained thereon and provides compliance between the component on which it is retained and a second component attached thereto via the receptacle and fastener.

2. The receptacle according to claim 1, wherein two legs on opposite sides of the base are shaped to form the compliant mechanism to provide the compliance in the direction of insertion of the fastener.

3. The receptacle according to claim 2, wherein the at least one leg shaped to form the compliant mechanism comprises at least on outer leg and an inner leg.

4. The receptacle according to claim 3, wherein the end portion of one of the at least one outer leg and the inner spring leg is bent to form a wing extending laterally from the base to provide compliance to the receptacle in its insertion direction.

5. The receptacle according to claim 4, wherein the at least one leg shaped to be the compliant mechanism comprises two outer legs.

6. The receptacle according to claim 5, wherein the end position of the two outer legs are joined.

7. The receptacle according to claim 6, wherein the inner leg is positioned at an acute angle to the at least one outer leg.

8. The receptacle according to claim 7, wherein the inner leg is positioned at an angle in the range 12-15° to the at least one outer leg.

9. The receptacle according to claim 4, wherein the end portion of one of the inner leg and at least one outer leg is bent back on itself to form a wing extending from the base such that, in use, the inner leg is positioned at an acute angle to the end portion of the outer leg to provide compliance to the receptacle in its insertion direction.

10. The receptacle according to claim 5, wherein the inner leg is located centrally between the two outer legs.

11. The receptacle according to claim 4, wherein the end portion of the at least one outer leg is, in use, positioned at an acute angle to the upper surface of the receiving component.

12. The receptacle according to claim 11, wherein the at least one outer leg is, in use, positioned at an angle of about 30° to a surface of the receiving component.

13. The receptacle according to claim 1, formed from metal.

14. The receptacle according to claim 13, formed from carbon steel.

15. A fastener and receptacle combination comprising a receptacle according to claim 1 which is for installation into a hole in a component and a fastener which is engaged with the hole in the base of the receptacle.

16. The fastener and receptacle combination according to claim 15, wherein the fastener is a quarter turn fastener.

17. The fastener and receptacle combination according to claim 15, wherein the panel is pre-mounted to the receptacle prior to installation in to the receiving component.

18. The receptacle according to claim 5, wherein the end portion of the at least one outer leg is, in use, positioned at an acute angle to the upper surface of the receiving component.

19. The receptacle according to claim 6, wherein the end portion of the at least one outer leg is, in use, positioned at an acute angle to the upper surface of the receiving component.

20. The receptacle according to claim 7, wherein the end portion of the at least one outer leg is, in use, positioned at an acute angle to the upper surface of the receiving component.
